(19) United States
(12) Patent Application Publication
(10) Pub. No.: US 2026/0009973 A1
(43) Pub. Date: Jan. 8, 2026

(54) CAMERA OPTICAL LENS

(71) Applicant: Changzhou AAC Raytech Optronics Co., Ltd., Changzhou City (CN)

(72) Inventors: Ronghui Cai, Changzhou (CN); Shunda Zhou, Changzhou (CN)

(21) Appl. No.: 18/974,730

(22) Filed: Dec. 9, 2024

Related U.S. Application Data
(63) Continuation of application No. PCT/CN2024/103516, filed on Jul. 4, 2024.

(51) Int. Cl. G02B 9/60; G02B 13/00

(52) U.S. Cl. CPC G02B 9/60; G02B 13/0045

(57) ABSTRACT

The present disclosure discloses a camera optical lens have five lenses. The five lenses from an object-side to an-image side are: a first lens having a positive refractive power; a second lens having a positive refractive power; a third lens having a negative refractive power; a fourth lens having a positive refractive power; a fifth lens having a negative refractive power; which satisfies following conditions: 0.12≤d1/TTL≤0.20; 5.00≤R3/R4≤15.00; −1.30≤(R5+R6)/(R5−R6)≤−1.00. The camera optical lens can achieve good optical performance while meeting the design requirement for large aperture, long focal length and ultra-thin.

### CROSS REFERENCE TO RELATED APPLICATIONS

The present application is a continuation of PCT Patent Application No. PCT/CN2024/103516, entitled “CAMERA OPTICAL LENS”, filed Jul. 4, 2024, which is incorporated by reference herein in its entirety.

### TECHNICAL FIELD

The present disclosure relates to the field of optical lens, in particular to a camera optical lens suitable for handheld devices, such as smart phones and digital cameras, and camera devices such as monitors and PC lens.

### BACKGROUND

With the rise of various smart devices in recent years, the demand for miniaturized camera optical lenses is increasing, and due to the reduction of the pixel size of light-sensitive devices, coupled with the development trend of electronic products with good functions, thin, lightweight, and portable appearance, miniaturized camera optical lenses with good imaging quality have become the mainstream of the current market. In order to obtain a better image quality, a multi-piece lens structure is mostly equipped. Moreover, with the development of technology and the increase of diversified needs of users, the pixel area of light-sensitive devices is constantly shrinking, and the requirements of the system for imaging quality are constantly improving, a camera optical lens with five lenses gradually appears in the lens design. There is an urgent need for camera optical lenses with good optical characteristics, small size and fully corrected aberrations.

### SUMMARY

In response to the foregoing technical problems, an object of embodiments of the present disclosure is to provide a camera optical lens, which can have good optical performance, and meet the design requirements for large aperture, wide-angle and ultra-thin.

To resolve the foregoing technical problems, the present disclosure provides a camera optical lens comprising five lenses, the five lenses from an object side to an image side in sequence being: a first lens having a positive refractive power; a second lens having a positive refractive power; a third lens having a negative refractive power; a fourth lens having a positive refractive power; a fifth lens having a negative refractive power; wherein the camera lens satisfies the following conditions: 0.12≤d1/TTL≤0.20; 5.00≤R3/R4≤15.00; −1.30≤(R5+R6)/(R5−R6)≤−1.00; where, d1 represents a thickness on-axis of the first lens; TTL represents a total track length of the camera optical lens; R3 represents a central curvature radius of the object side surface of the second lens; R4 represents a central curvature radius of the image side surface of the second lens; R5 represents a central curvature radius of the object side surface of the third lens; R6 represents a central curvature radius of the image side surface of the third lens.

As an improvement, wherein the camera optical lens further satisfies following conditions: 1.00≤f1/f≤1.35; where, f1 represents a focal length of the first lens; f represents a focal length of the camera optical lens.

As an improvement, wherein the camera optical lens further satisfies the following conditions: 0.70≤d7/d9≤2.00; where, d7 represents a thickness on-axis of the fourth lens; d9 represents a thickness on-axis of the fifth lens.

As an improvement, wherein the camera optical lens further satisfies the following conditions: (IH*FOV)/D≤166.66°; where, IH represents an image height of 1.0H of the camera optical lens; FOV represents a field of view in a diagonal direction of the camera optical lens; D represents a diameter of an object side surface of the first lens.

As an improvement, wherein the camera optical lens further satisfies the following conditions: 3.00≤d3/d4≤20.00; where, d3 represents a thickness on-axis of the second lens; d4 represents a distance on-axis from an image side surface of the second lens to an object side surface of the third lens.

As an improvement, wherein an object side surface of the first lens is convex in the paraxial region, an image side surface of the first lens is convex in the paraxial region; and the camera optical lens further satisfies the following conditions: −1.70≤(R1+R2)/(R1−R2)≤−0.51; where, R1 represents a central curvature radius of the object side surface of the first lens; R2 represents a central curvature radius of the image side surface of the first lens.

As an improvement, wherein an object side surface of the second lens is concave in the paraxial region, an image side surface of the second lens is convex in the paraxial region; and the camera optical lens further satisfies the following conditions: 0.51≤f2/f≤1.73; 0.57≤(R3+R4)/(R3−R4)≤2.10; 0.04≤d3/TTL≤0.21; where, f2 represents a focal length of the second lens; f represents a focal length of the camera optical lens; d3 represents a thickness on-axis of the second lens.

As an improvement, wherein an object side surface of the third lens is concave in the paraxial region, an image side surface of the third lens is convex in the paraxial region; and the camera optical lens further satisfies the following conditions: −1.46≤f3/f≤−0.42; 0.02≤d5/TTL≤0.08; where, f3 represents a focal length of the third lens; f represents a focal length of the camera optical lens; TTL represents a total track length of the camera optical lens.

As an improvement, wherein an image side surface of the fourth lens is convex in the paraxial region; and the camera optical lens further satisfies the following conditions: 0.26≤f4/f≤0.84; 0.47≤(R7+R8)/(R7−R8)≤1.74; 0.07≤d7/TTL≤0.28; where, f4 represents a focal length of the fourth lens; f represents a focal length of the camera optical lens; R7 represents a central curvature radius of the object side surface of the fourth lens; R8 represents a central curvature radius of the image side surface of the fourth lens; d7 represents a thickness on-axis of the fourth lens.

As an improvement, wherein an object side surface of the fifth lens is convex in the paraxial region, an image side surface of the fifth lens is concave in the paraxial region; and the camera optical lens further satisfies the following conditions: −1.12≤f5/f≤−0.35; 0.52≤(R9+R10)/(R9−R10)≤2.07; 0.05≤d9/TTL≤0.29; where, f5 represents a focal length of the fifth lens; f represents a focal length of the camera optical lens; R9 represents a central curvature radius of the object side surface of the fifth lens; R10 represents a central curvature radius of the image side surface of the fifth lens; d9 represents a thickness on-axis of the fifth lens.

The beneficial effect of the present disclosure are as follows. The camera optical lens designed according to the present disclosure has excellent optical characteristics, and the camera optical lens can meet the design requirements for large aperture, wide-angle and ultra-thin. The camera optical lens is particularly suitable for cellular phone camera lens assemblies and WEB camera lenses, which includes camera elements such as CCD (Charge-Coupled Device), CMOS (Complementary Metal-Oxide-Semiconductor) and other camera elements for high pixels.

### BRIEF DESCRIPTION OF THE DRAWINGS

In order to more clearly illustrate the technical solutions in the embodiments of the present disclosure, the accompanying drawings to be used in the description in the embodiments will be briefly introduced hereinafter, and the following is a brief introduction of the drawings required in the description of the embodiments. It is obvious that the accompanying drawings in the description hereinafter are only some of the embodiments of the present disclosure, and that for a person having ordinary skill in the art, other accompanying drawings can also be obtained according to these drawings without creative labor.

FIG. 1 is a schematic diagram of a camera optical lens in accordance with a first embodiment of the present disclosure;

FIG. 2 shows the longitudinal aberration of the camera optical lens shown in FIG. 1;

FIG. 3 shows the lateral color of the camera optical lens shown in FIG. 1;

FIG. 4 presents a schematic diagram of the field curvature and distortion of the camera optical lens shown in FIG. 1;

FIG. 5 is a schematic diagram of t a camera optical lens in accordance with a second embodiment of the present disclosure;

FIG. 6 shows the longitudinal aberration of the camera optical lens shown in FIG. 5;

FIG. 7 shows the lateral color of the camera optical lens shown in in FIG. 5;

FIG. 8 presents a schematic diagram of the field curvature and distortion of the camera optical lens shown in FIG. 5;

FIG. 9 is a schematic diagram of a camera optical lens in accordance with a third embodiment of the present disclosure;

FIG. 10 shows the longitudinal aberration of the camera optical lens shown in FIG. 9;

FIG. 11 shows the lateral color of the camera optical lens shown in in FIG. 9;

FIG. 12 presents a schematic diagram of the field curvature and distortion of the camera optical lens shown in FIG. 9;

FIG. 13 is a schematic diagram of a camera optical lens in accordance with a fourth embodiment of the present disclosure;

FIG. 14 shows the longitudinal aberration of the camera optical lens shown in FIG. 13;

FIG. 15 shows the lateral color of the camera optical lens shown in FIG. 13;

FIG. 16 presents a schematic diagram of the field curvature and distortion of the camera optical lens shown in FIG. 13;

FIG. 17 is a schematic diagram of a camera optical lens in accordance with a comparative embodiment of the present disclosure;

FIG. 18 shows the longitudinal aberration of the camera optical lens shown in FIG. 17;

FIG. 19 shows the lateral color of the camera optical lens shown in FIG. 17; and

FIG. 20 presents a schematic diagram of the field curvature and distortion of the camera optical lens shown in FIG. 17.

### DETAILED DESCRIPTION OF THE EMBODIMENTS

To make the technical problems to be solved, technical solutions and beneficial effects of the present disclosure more apparent, the present disclosure is described in further detail together with the figure and the embodiments. It should be understood the specific embodiments described hereby is only to explain the present disclosure, not intended to limit the disclosure. It is understandable to a person having ordinary skill in the art that, in various embodiments of the disclosure, many technical details are proposed to enable the reader to better understand the present disclosure. However, even without the technical details and various variations and modifications based on the following embodiments, the technical solution claimed to be protected by the present disclosure can be realized.

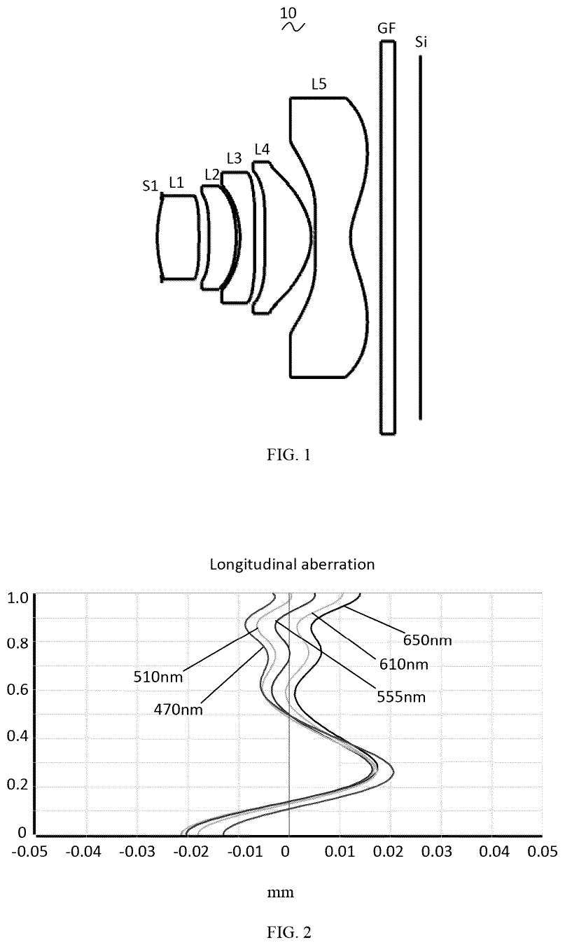

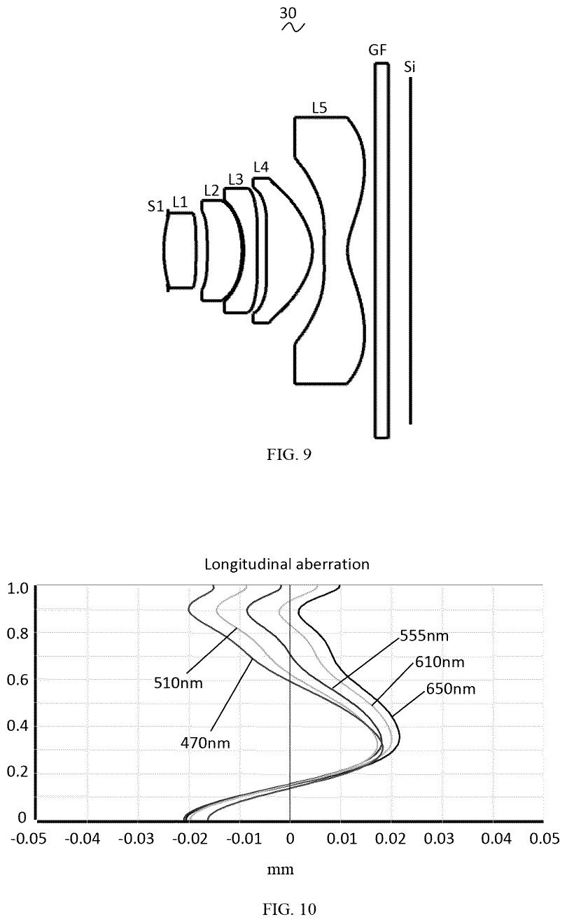

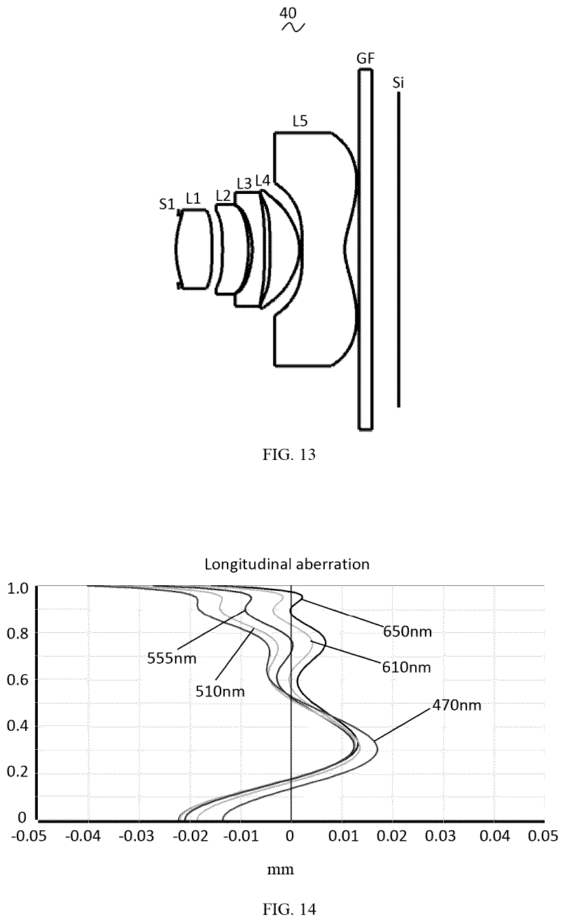

Referring to FIG. 1, FIG. 5, FIG. 9 and FIG. 13, the present disclosure provides a camera optical lens 10, 20, 30, and 40. FIG. 1, FIG. 5, FIG. 9, and FIG. 13 respectively shows the camera optical lens 10, the camera optical lens 20, the camera optical lens 30, and the camera optical lens 40. The camera optical lens includes five lenses in total. Specifically, from the object side to the image side, the camera optical lens includes in sequence: an aperture S1, a first lens L1, a second lens L2, a third lens L3, a fourth lens L4, and a fifth lens L5. Optical elements like an optical filter GF may be arranged between the fifth lens L5 and the image surface Si.

The first lens L1 has a positive refractive power. The second lens L2 has a positive refractive power. The third lens L3 has a negative refractive power. The fourth lens L4 has a positive refractive power. The fifth lens L5 has a negative refractive power. In other optional embodiments, the respective lens of the camera optical lens may also have other refractive power.

The first lens L1 is made of plastic material. The second lens L2 is made of plastic material. The third lens L3 is made of plastic material. The fourth lens L4 is made of plastic material. The fifth lens L5 is made of plastic material. In other optional embodiments, the respective lens of the camera optical lens may also be made of other materials.

The thickness on-axis of the first lens L1 is defined as d1. The total track length of the camera optical lens is defined as TTL. The following condition should be satisfied: 0.12≤d1/TTL≤0.20, which fixes the ratio between the thickness on-axis d1 of the first lens L1 and the total track length TTL of the camera optical lens. It helps to control the thickness of the first lens L1 within the relational range, facilitates injection molding, and facilitates light collection, thus ensuring wide angle design.

The central curvature radius of the object side surface of the second lens L2 is defined as R3, and the central curvature radius of the image side surface of the second lens L2 is defined as R4. The following condition should be satisfied: 5.00≤R3/R4≤15.00, which fixes the shape of the second lens L2. When the condition is satisfied, the degree of deflection of light passing through second lens L2 can be eased, and the lateral color can be effectively corrected, so that the lateral color is less than or equal to 2.0 μm.

The central curvature radius of the object side surface of the third lens L3 is defined as R3, and the central curvature radius of the image side surface of the third lens L3 is defined as R4. The following condition should be satisfied: −1.30≤(R5+R6)/(R5−R6)≤−1.00, by which, the shape of the third lens L3 is fixed, the distortion and astigmatism of the camera optical lens can be effectively corrected, so that the distortion is less than or equal to 2.5%, the possibility of dark corners can be reduced.

In the case of satisfying the above conditions, the camera optical lens 10, 20, 30 and 40 has good optical performance and can meet the design requirements of a large aperture, wide angle and ultra-thin. Based on the characteristics of the camera optical lens 10, 20, 30 and 40, the camera optical lens 10, 20, 30 and 40 is particularly suitable for cellular phone camera lens assemblies and WEB camera lenses, which includes camera elements such as CCD and CMOS for high pixel.

Based on the above conditions and the functions that can be achieved, the characteristics of each lens are further refined as follows.

The focal length of the first lens L1 is defined as f1. The following condition should be satisfied: 1.00≤f1/f≤1.35, which fixes the ration between the focal length f1 of the first lens L1 and the focal length f of the camera optical lens. By distributing the focal power of the first lens L1 appropriately, the camera optical lens can have better imaging quality and lower sensitivity.

The thickness on-axis of the fourth lens L4 is defined as d7. The thickness on-axis of the fifth lens L5 is defined as d9. The following condition should be satisfied: 0.70≤d7/d9≤2.00, which fixes the ratio between the thickness on-axis d7 of the fourth lens L4 and the thickness on-axis d9 of the fifth lens L5. It helps to compress the total track length of the camera optical lens within the range of the condition and helps to control the thickness of the first lens L1, which is convenient for injection molding.

The image height of 1.0H of the camera optical lens is defined as IH. The field of view in the diagonal direction is defined as FOV. The diameter of the object side surface of the first lens is defined as D. The following condition should be satisfied: (IH*FOV)/D≤166.66°. By controlling the IH and FOV, the front aperture can be effectively controlled.

The thickness on-axis of the second lens L2 is defined as d3. The distance on-axis between the image side surface of the second lens L2 and the object side surface of the third lens L3 is defined as d4. The following condition should be satisfied: 3.00≤d3/d4≤20.00, which fixes the ratio between the air interval between the second lens L2 and the third lens L3 and the thickness on-axis d3 of the second lens L2. When the condition is satisfied, it is helpful for lens processing and lens assembly.

The object side surface of the first lens L1 is convex in a paraxial region, and the image side surface of the first lens L1 is convex in the paraxial region. The object side surface and the image side surface of the first lens L1 may also be provided with other concave and convex distributions.

The central curvature radius of the object side surface of the first lens L1 is defined as R1, and the central curvature radius of the image side surface of the first lens L1 is defined as R2. The following condition should be satisfied: −1.70≤(R1+R2)/(R1−R2)≤−0.51, by which, the shape of the first lens L1 is reasonably controlled, it is beneficial for efficiently correcting the spherical aberration of the system. Preferably, the following condition shall be satisfied: −1.06≤(R1+R2)/(R1−R2)≤−0.64.

The object side surface of the second lens L2 is concave in the paraxial region, and the image side surface of the second lens L2 is convex in the paraxial region. The object side surface of the second lens L2 may also be provided with other concave and convex distributions.

The focal length of the second lens L2 is defined as f2. The following condition should be satisfied: 0.51≤f2/f≤1.73, which fixes the ration between the focal length f2 of the second lens L2 and the focal length f of the camera optical lens. By controlling the positive focal power of the second lens L2 in a reasonable range, it is beneficial for correcting the aberration (i.e., lateral color) of the camera optical lens. Preferably, the following condition shall be satisfied: 0.82≤f2/f≤1.38.

The central curvature radius of the object side surface of the second lens L2 is defined as R3, and the central curvature radius of the image side surface of the second lens L2 is defined as R4. The following condition should be satisfied: 0.57≤(R3+R4)/(R3−R4)≤2.10, which fixes the shape of the second lens L2. When the condition is satisfied, it is beneficial for correcting the aberration of the axis. Preferably, the following condition shall be satisfied, 0.91≤(R3+R4)/(R3−R4)≤1.68 is satisfied.

The thickness on-axis of the second lens L2 is defined as d3. The following condition should be satisfied: 0.04≤d3/TTL≤0.21, by which, it is beneficial for the realization of ultra-thin. Preferably, the following condition shall be satisfied: 0.06≤d3/TTL≤0.17.

The object side surface of the third lens L3 is concave in the paraxial region, and the image side surface of the third lens L3 is convex in the paraxial region. The object side surface and the image side surface of the third lens L3 may also be provided with other concave and convex distributions.

The focal length of the third lens L3 is defined as f3. The following condition: −1.46≤f3/f≤−0.42 should be satisfied, which fixes the ration between the focal length f3 of the third lens L3 and the focal length f of the camera optical lens. By distributing the focal length f3 of the third lens L3 appropriately, the camera optical lens can have better imaging quality and lower sensitivity. Preferably, the following condition shall be satisfied: −0.91≤f3/f≤−0.53.

The thickness on-axis of the third lens L3 is defined as d5. The following condition should be satisfied: 0.025d5/TTL≤0.08, by which, it is beneficial for the realization of ultra-thin. Preferably, the following condition shall be satisfied, 0.04≤d5/TTL≤0.07.

The object side surface of the fourth lens L4 is concave or convex in the paraxial region, and the image side surface of the fourth lens L4 is convex in the paraxial region. The image side surface of the fourth lens L4 may also be provided with other concave and convex distributions.

The focal length of the fourth lens L4 is defined as f4. The following condition: 0.26≤f4/f≤0.84 should be satisfied. By distributing the focal power of the fourth lens L4 appropriately, the camera optical lens can have better imaging quality and lower sensitivity. Preferably, the following condition shall be satisfied: 0.41≤f4/f≤0.67.

The central curvature radius of the object side surface of the fourth lens L4 is defined as R7, and the central curvature radius of the image side surface of the fourth lens L4 is defined as R8. The following condition should be satisfied: 0.47≤(R7+R8)/(R7−R8)≤1.74, which fixes the shape of the fourth lens L4. When the condition is satisfied, it is beneficial for correcting the aberration of the image of the off axis drawing angle, among other things, as the camera optical lens 10 with ultra-thin and wide angle is developed. Preferably, the following condition shall be satisfied: 0.76≤(R7+R8)/(R7−R8)≤1.39.

The thickness on-axis of the fourth lens L4 is defined as d7. The following condition should be satisfied: 0.07≤d7/TTL≤0.28, by which, it is beneficial for the realization of ultra-thin. Preferably, the following condition shall be satisfied: 0.11≤d7/TTL≤0.23.

The object side surface of the fifth lens L5 is convex in the paraxial region, and the image side surface of the fifth lens L5 is concave in the paraxial region. The object side surface and the image side surface of the fifth lens L5 may also be provided with other concave and convex distributions.

The focal length of the camera optical lens 10 is defined as f5. The following condition should be satisfied: −1.12≤f5/f≤−0.35, which restricts the fifth lens L5. The restriction of the fifth lens L5 can effectively make the light angle of the camera optical lens smooth and reduce the tolerance sensitivity. Preferably, the following condition shall be satisfied: −0.70≤f5/f≤−0.43.

The central curvature radius of the object side surface of the fifth lens L5 is defined as R9, and the central curvature radius of the image side surface of the fifth lens L5 is defined as R10. The following condition should be satisfied: 0.52≤(R9+R10)/(R9−R10)≤2.07, which fixes the shape of the fifth lens L5. When the condition is satisfied, it is beneficial for correcting the aberration of the image of the off axis drawing angle, among other things, with the development of ultra-thin and wide angle. Preferably, the following condition shall be satisfied, 0.83≤(R9+R10)/(R9−R10)≤1.66.

The thickness on-axis of the fifth lens L5 is defined as d9. The following condition should be satisfied: 0.05≤d9/TTL≤0.29, by which, it is beneficial for the realization of ultra-thin. Preferably, the following condition shall be satisfied: 0.08≤d9/TTL≤0.23.

The maximum image height of the camera optical lens is defined as IH. The following condition should be satisfied: TTL/IH≤1.554, which is beneficial for the realization of ultra-thin.

The FOV (field of view) of the camera optical lens is greater than or equal to 89.00°, thereby achieving a wide-angle of the camera optical lens.

The F number of the camera optical lens is defined as FNO. The camera optical lens satisfies the following condition: FNO≤2.3, which makes the camera optical lens have a large aperture and a good optical performance.

The camera optical lens of the present disclosure will be described below by way of examples. The various symbols recorded in each example are shown below. The focal length, distance on-axis, center curvature radius, and thickness on-axis are all in units of mm.

TTL: Total track length (the distance from the object-side surface of the first lens L1 to the image surface Si of the camera optical lens along the optical axis), and the unit of TTL is mm.

Aperture value FNO: a ratio of the effective focal length of the camera optical lens to the entrance pupil diameter of the camera optical lens.

The technical scheme of the present disclosure is specifically described in four embodiments, and at the same time, a contrast embodiment is provided as a reference, and the technical effect of the present disclosure cannot be realized beyond the scope of the above conditions.

### First Embodiment

Table 1 shows the design data of the camera optical lens 10 in the first embodiment of the present disclosure. FIG. 1 shows a schematic diagram of a structure of a camera optical lens 10 in the first embodiment of the present disclosure. The object side surface of the fourth lens L4 is concave in the paraxial region.

TABLE 1

| | R | d | | nd | | vd | |
|---|---|---|---|---|---|---|---|
| S1 | ∞ | d0= | −0.073 | | | | |
| R1 | 1.978 | d1= | 0.646 | nd1 | 1.5444 | ν1 | 55.82 |
| R2 | −14.929 | d2= | 0.155 | | | | |
| R3 | −11.592 | d3= | 0.422 | nd2 | 1.5444 | ν2 | 55.82 |
| R4 | −1.410 | d4= | 0.060 | | | | |
| R5 | −1.126 | d5= | 0.226 | nd3 | 1.6610 | ν3 | 20.53 |
| R6 | −22.709 | d6= | 0.157 | | | | |
| R7 | −27.598 | d7= | 0.726 | nd4 | 1.6153 | ν4 | 25.94 |
| R8 | −0.835 | d8= | 0.060 | | | | |
| R9 | 4.686 | d9= | 0.546 | nd5 | 1.6400 | ν5 | 23.54 |
| R10 | 0.751 | d10= | 0.476 | | | | |
| R11 | ∞ | d11= | 0.210 | ndg | 1.5168 | νg | 64.17 |
| R12 | ∞ | d12= | 0.397 | | | | |

In which, the meaning of the various symbols is as follows.
S1: Aperture;
R: The curvature radius at the center of the optical surface;
R1: The central curvature radius of the object side surface of the first lens L1;
R2: The central curvature radius of the image side surface of the first lens L1;
R3: The central curvature radius of the object side surface of the second lens L2;
R4: The central curvature radius of the image side surface of the second lens L2;
R5: The central curvature radius of the object side surface of the third lens L3;
R6: The central curvature radius of the image side surface of the third lens L3;
R7: The central curvature radius of the object side surface of the fourth lens L4;
R8: The central curvature radius of the image side surface of the fourth lens L4;
R9: The central curvature radius of the object side surface of the fifth lens L5;
R10: The central curvature radius of the image side surface of the fifth lens L5;
R11: The central curvature radius of the object side surface of the optical filter GF;
R12: The center curvature radius of the image side surface of the optical filter GF;
d: The thickness on-axis of the lens, and the distance on-axis between the lenses;
d0: The distance on-axis from the aperture S1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 and the object side surface of the third lens L3;
d5: The thickness on-axis of the third lens L3;
d6: The distance on-axis from the image side surface of the third lens L3 to the object side surface of the fourth lens L4;
d7: The thickness on-axis of the fourth lens L4;
d8: The distance on-axis from the image side surface of the fourth lens L4 to the object side surface of the fifth lens L5;
d9: The thickness on-axis of the fifth lens L5;
d10: The distance on-axis from the image side surface of the fifth lens L5 and the object side surface of the optical filter GF;
d11: The thickness on-axis of the optical filter GF;
d12: The distance on-axis from the image side surface of the optical filter GF to the image surface Si;
nd: The refractive power of d line (d line is green light with a wavelength of 550 nm);
nd1: The refractive power of the d line of the first lens L1;
nd2: The refractive power of the d line of the second lens L2;
nd3: The refractive power of the d line of the third lens L3;
nd4: The refractive power of the d line of the fourth lens L4;
nd5: The refractive power of the d line of the fifth lens L5;
ndg: The refractive power of d line of the optical filter GF;
vd: The abbe number;
v1: The abbe number of the first lens L1;
v2: The abbe number of the second lens L2;
v3: The abbe number of the third lens L3;
v4: The abbe number of the fourth lens L4;
v5: The abbe number of the fifth lens L5;
vg: The abbe number of the optical filter GF.

Table 2 shows aspherical surface data of the camera optical lens 10 in the first embodiment of the present disclosure.

TABLE 2

| | Conic | | | | | |
|---|---|---|---|---|---|---|
| | coefficients | Aspheric surface coefficients | | | | |
| | k | A4 | A6 | A8 | A10 | A12 |
| R1 | −2.6733E+01 | 4.8559E−01 | −3.8458E+00 | 3.8369E+01 | −2.7899E+02 | 1.2934E+03 |
| R2 | 4.7613E+02 | −1.8070E−01 | 1.2946E+00 | −3.6480E+01 | 3.7716E+02 | −2.1718E+03 |
| R3 | 9.2942E+01 | −6.7012E−01 | 1.9543E+01 | −5.0952E+02 | 8.2092E+03 | −8.9585E+04 |
| R4 | −3.7967E−02 | 2.2441E+00 | −4.4543E+01 | 6.4170E+02 | −5.9606E+03 | 3.4255E+04 |
| R5 | −3.5387E−03 | 2.6722E+00 | −4.3721E+01 | 5.1723E+02 | −3.9666E+03 | 1.7957E+04 |
| R6 | −9.9900E+02 | 1.2163E+00 | −2.0544E+01 | 1.9837E+02 | −1.2802E+03 | 5.6873E+03 |
| R7 | −8.2216E+02 | 5.4164E−01 | −6.6088E+00 | 2.5133E+01 | 8.5739E+01 | −1.4487E+03 |
| R8 | −1.0029E+00 | 3.0899E−01 | −1.9794E+00 | 9.0404E+00 | −1.3787E+01 | −6.2742E+01 |
| R9 | 5.6367E−01 | −4.4241E−01 | −1.7758E+00 | 1.6403E+01 | −6.1705E+01 | 1.4291E+02 |
| R10 | −1.0037E+00 | −1.3409E+00 | 2.8948E+00 | −5.1289E+00 | 6.7120E+00 | −6.4521E+00 |
| | Conic | | | | | |
| | coefficients | Aspheric surface coefficients | | | | |
| | k | A14 | A16 | A18 | A20 | A22 |
| R1 | −2.6733E+01 | −3.7521E+03 | 6.5689E+03 | −6.3217E+03 | 2.5563E+03 | 0.0000E+00 |
| R2 | 4.7613E+02 | 7.4650E+03 | −1.5227E+04 | 1.7008E+04 | −7.9912E+03 | 0.0000E+00 |
| R3 | 9.2942E+01 | 6.8925E+05 | −3.8314E+06 | 1.5583E+07 | −4.6445E+07 | 1.0036E+08 |
| R4 | −3.7967E−02 | −1.1592E+05 | 1.6206E+05 | 4.0496E+05 | −2.6982E+06 | 6.8747E+06 |
| R5 | −3.5387E−03 | −3.6739E+04 | −6.7456E+04 | 7.3265E+05 | −2.5414E+06 | 5.1981E+06 |
| R6 | −9.9900E+02 | −1.7923E+04 | 4.0899E+04 | −6.8150E+04 | 8.2721E+04 | −7.2132E+04 |
| R7 | −8.2216E+02 | 7.9271E+03 | −2.6037E+04 | 5.7501E+04 | −8.8478E+04 | 9.5300E+04 |
| R8 | −1.0029E+00 | 4.5132E+02 | −1.4366E+03 | 2.8941E+03 | −3.9683E+03 | 3.7583E+03 |
| R9 | 5.6367E−01 | −2.2769E+02 | 2.6172E+02 | −2.2109E+02 | 1.3737E+02 | −6.1952E+01 |
| R10 | −1.0037E+00 | 4.5979E+00 | −2.4453E+00 | 9.7144E−01 | −2.8646E−01 | 6.1720E−02 |

| | Conic | | | | |
|---|---|---|---|---|---|
| | coefficients | Aspheric surface coefficients | | | |
| | k | A24 | A26 | A28 | A30 |
| R1 | −2.6733E+01 | 0.0000E+00 | 0.0000E+00 | 0.0000E+00 | 0.0000E+00 |
| R2 | 4.7613E+02 | 0.0000E+00 | 0.0000E+00 | 0.0000E+00 | 0.0000E+00 |
| R3 | 9.2942E+01 | −1.5307E+08 | 1.5623E+08 | −9.5730E+07 | 2.6610E+07 |
| R4 | −3.7967E−02 | −1.0226E+07 | 9.2456E+06 | −4.7289E+06 | 1.0535E+06 |
| R5 | −3.5387E−03 | −6.7932E+06 | 5.5915E+06 | −2.6505E+06 | 5.5299E+05 |
| R6 | −9.9900E+02 | 4.3889E+04 | −1.7642E+04 | 4.1985E+03 | −4.4667E+02 |
| R7 | −8.2216E+02 | −7.0541E+04 | 3.4206E+04 | −9.7858E+03 | 1.2519E+03 |
| R8 | −1.0029E+00 | −2.4215E+03 | 1.0131E+03 | −2.4797E+02 | 2.6927E+01 |
| R9 | 5.6367E−01 | 1.9691E+01 | −4.1739E+00 | 5.2873E−01 | −3.0235E−02 |
| R10 | −1.0037E+00 | −9.4284E−03 | 9.6630E−04 | −5.9542E−05 | 1.6661E−06 |

For convenience, the aspheric of each lens is used the aspherical surfaces shown in formula (1) below. However, the present disclosure is not limited to the aspheric polynomial form represented by the formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} . \qquad ( 1 )$$

Here k is the cone coefficient, A4, A6, A8, A10, A12, A14, A16, A18, A20, A22, A24, A26, A28, and A30 are aspheric coefficients, c is the curvature at the center of the optical surface, r is the vertical distance between the point on the aspheric curve and the optical axis, and z is the aspherical depth (i.e., the vertical distance between a point on the aspherical surface r from the optical axis and a section tangent to the vertex on the aspherical optical axis).

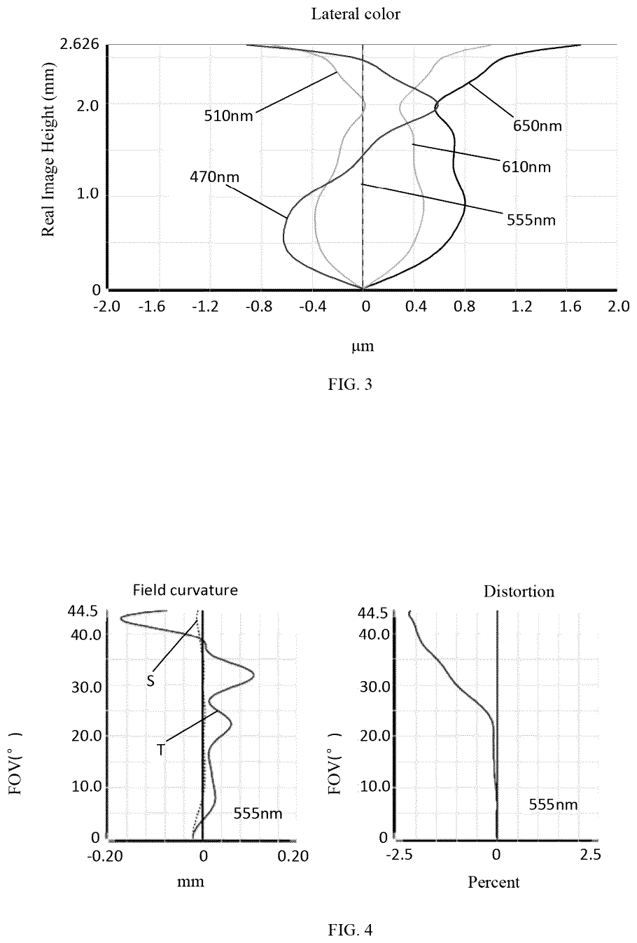

FIG. 2 and FIG. 3 respectively show the longitudinal aberration and lateral color schematic diagrams after light with wavelengths of 650 nm, 610 nm, 555 nm, 510 nm, and 470 nm passes through the camera optical lens 10 in the first embodiment. FIG. 4 shows the schematic diagrams of the field curvature and distortion after light with a wavelength of 555 nm passes through the camera optical lens 10 in the first embodiment. The field curvature S in FIG. 4 is a field curvature in the sagittal direction, and T is the field curvature in the meridian direction.

In this embodiment, the pupil entering diameter (ENPD) of the camera optical lens 10 is 1.213 mm, the image height (IH) of 1.0H is 2.626 mm, and the field of view (FOV) in the diagonal direction is 89.00°. The camera optical lens 10 can meet the design requirements of large aperture, wide-angle and ultra-thin, and chromatic aberrations on-axis and chromatic aberrations off-axis are adequately corrected. And the camera optical lens 10 has excellent optical characteristics.

### Second Embodiment

The meaning of symbols in the second embodiment is the same as that in the first embodiment.

FIG. 5 shows a schematic diagram of a structure of a camera optical lens 20 in the second embodiment of the present disclosure. The object side surface of the fourth lens L4 is concave in the paraxial region.

Table 3 and Table 4 show design data of the camera optical lens 20 in the second embodiment of the present disclosure.

TABLE 3

| | R | d | | nd | | vd | |
|---|---|---|---|---|---|---|---|
| S1 | ∞ | d0= | −0.064 | | | | |
| R1 | 1.990 | d1= | 0.773 | nd1 | 1.5444 | ν1 | 55.82 |
| R2 | −21.254 | d2= | 0.148 | | | | |
| R3 | −20.313 | d3= | 0.310 | nd2 | 1.5444 | ν2 | 55.82 |
| R4 | −1.356 | d4= | 0.103 | | | | |
| R5 | −1.050 | d5= | 0.170 | nd3 | 1.6610 | ν3 | 20.53 |
| R6 | −8.101 | d6= | 0.149 | | | | |
| R7 | −22.497 | d7= | 0.697 | nd4 | 1.6153 | ν4 | 25.94 |
| R8 | −0.849 | d8= | 0.106 | | | | |
| R9 | 5.693 | d9= | 0.546 | nd5 | 1.6400 | ν5 | 23.54 |
| R10 | 0.749 | d10= | 0.455 | | | | |
| R11 | ∞ | d11= | 0.210 | ndg | 1.5168 | νg | 64.17 |
| R12 | ∞ | d12= | 0.204 | | | | |

Table 4 shows aspherical surface data of each lens of the camera optical lens 20 in the second embodiment of the present disclosure.

TABLE 4

| | Conic | | | | | |
|---|---|---|---|---|---|---|
| | coefficients | Aspheric surface coefficients | | | | |
| | k | A4 | A6 | A8 | A10 | A12 |
| R1 | −2.1956E+01 | 4.5686E−01 | −4.0706E+00 | 3.9953E+01 | −2.8099E+02 | 1.2842E+03 |
| R2 | 4.8454E+02 | −2.2840E−01 | 1.1598E+00 | −3.6663E+01 | 3.7798E+02 | −2.1645E+03 |
| R3 | −1.4635E+02 | −7.5924E−01 | 1.9055E+01 | −5.0921E+02 | 8.2046E+03 | −8.9554E+04 |
| R4 | 5.5537E−01 | 1.9355E+00 | −4.3989E+01 | 6.4176E+02 | −5.9618E+03 | 3.4256E+04 |
| R5 | −3.5601E−02 | 2.5727E+00 | −4.3920E+01 | 5.1879E+02 | −3.9687E+03 | 1.7959E+04 |
| R6 | −6.7642E+02 | 1.1754E+00 | −2.0684E+01 | 1.9866E+02 | −1.2805E+03 | 5.6873E+03 |
| R7 | 4.7594E+02 | 4.5896E−01 | −6.2723E+00 | 2.4653E+01 | 8.5565E+01 | −1.4478E+03 |
| R8 | −9.8534E−01 | 2.7556E−01 | −1.9547E+00 | 9.0337E+00 | −1.3790E+01 | −6.2766E+01 |
| R9 | 1.1301E+00 | −4.4431E−01 | −1.7947E+00 | 1.6405E+01 | −6.1706E+01 | 1.4291E+02 |
| R10 | −9.8171E−01 | −1.3375E+00 | 2.8908E+00 | −5.1285E+00 | 6.7121E+00 | −6.4521E+00 |
| | Conic | | | | | |
| | coefficients | Aspheric surface coefficients | | | | |
| | k | A14 | A16 | A18 | A20 | A22 |
| R1 | −2.1956E+01 | −3.7053E+03 | 6.4401E+03 | −6.1218E+03 | 2.4604E+03 | 0.0000E+00 |
| R2 | 4.8454E+02 | 7.4477E+03 | −1.5263E+04 | 1.7121E+04 | −8.0456E+03 | 0.0000E+00 |
| R3 | −1.4635E+02 | 6.8920E+05 | −3.8314E+06 | 1.5583E+07 | −4.6445E+07 | 1.0036E+08 |
| R4 | 5.5537E−01 | −1.1592E+05 | 1.6206E+05 | 4.0495E+05 | −2.6981E+06 | 6.8748E+06 |
| R5 | −3.5601E−02 | −3.6754E+04 | −6.7441E+04 | 7.3266E+05 | −2.5413E+06 | 5.1980E+06 |
| R6 | −6.7642E+02 | −1.7923E+04 | 4.0898E+04 | −6.8150E+04 | 8.2721E+04 | −7.2132E+04 |
| R7 | 4.7594E+02 | 7.9265E+03 | −2.6037E+04 | 5.7501E+04 | −8.8478E+04 | 9.5300E+04 |
| R8 | −9.8534E−01 | 4.5133E+02 | −1.4367E+03 | 2.8942E+03 | −3.9683E+03 | 3.7582E+03 |
| R9 | 1.1301E+00 | −2.2769E+02 | 2.6172E+02 | −2.2109E+02 | 1.3737E+02 | −6.1952E+01 |
| R10 | −9.8171E−01 | 4.5979E+00 | −2.4453E+00 | 9.7144E−01 | −2.8646E−01 | 6.1720E−02 |

| | Conic | | | | |
|---|---|---|---|---|---|
| | coefficients | Aspheric surface coefficients | | | |
| | k | A24 | A26 | A28 | A30 |
| R1 | −2.1956E+01 | 0.0000E+00 | 0.0000E+00 | 0.0000E+00 | 0.0000E+00 |
| R2 | 4.8454E+02 | 0.0000E+00 | 0.0000E+00 | 0.0000E+00 | 0.0000E+00 |
| R3 | −1.4635E+02 | −1.5307E+08 | 1.5623E+08 | −9.5731E+07 | 2.6613E+07 |
| R4 | 5.5537E−01 | −1.0226E+07 | 9.2455E+06 | −4.7290E+06 | 1.0539E+06 |
| R5 | −3.5601E−02 | −6.7933E+06 | 5.5917E+06 | −2.6501E+06 | 5.5243E+05 |
| R6 | −6.7642E+02 | 4.3889E+04 | −1.7642E+04 | 4.1985E+03 | −4.4674E+02 |
| R7 | 4.7594E+02 | −7.0541E+04 | 3.4206E+04 | −9.7856E+03 | 1.2518E+03 |
| R8 | −9.8534E−01 | −2.4215E+03 | 1.0131E+03 | −2.4796E+02 | 2.6927E+01 |
| R9 | 1.1301E+00 | 1.9691E+01 | −4.1739E+00 | 5.2873E−01 | −3.0235E−02 |
| R10 | −9.8171E−01 | −9.4284E−03 | 9.6631E−04 | −5.9542E−05 | 1.6661E−06 |

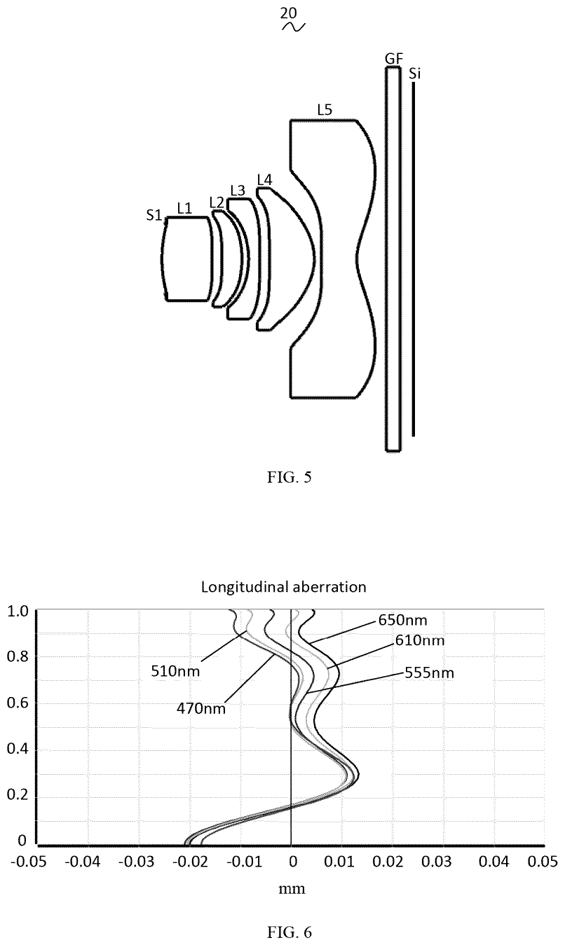

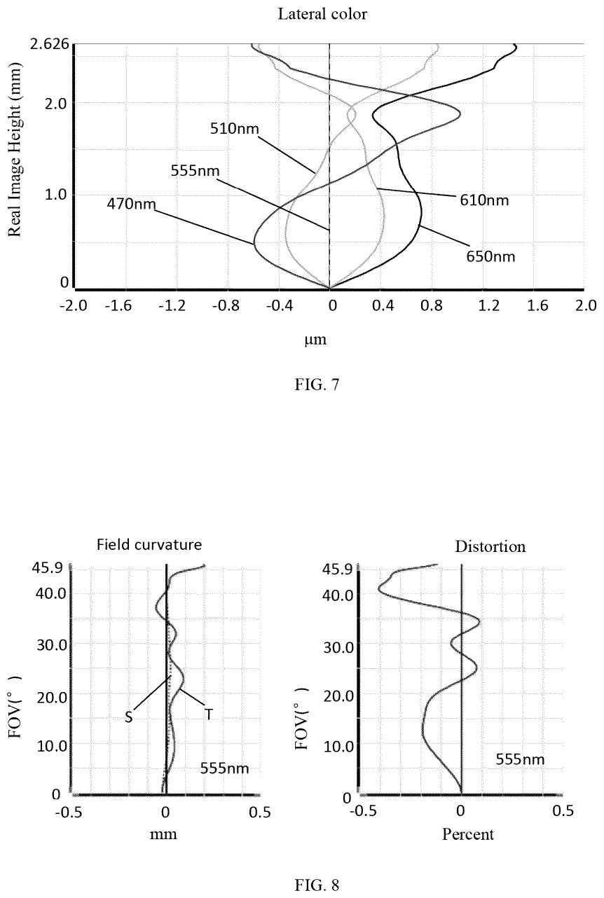

FIG. 6 and FIG. 7 respectively show the longitudinal aberration and lateral color schematic diagrams after light with wavelengths of 650 nm, 610 nm, 555 nm, 510 nm, and 470 nm passes through the camera optical lens 20 in the second embodiment. FIG. 8 shows the schematic diagrams of the field curvature and distortion after light with a wavelength of 555 nm passes through the camera optical lens 20 in the second implementation. The field curvature S in FIG. 8 is a field curvature in the sagittal direction, and T is the field curvature in the meridian direction.

In this embodiment, the pupil entering diameter (ENPD) of the camera optical lens 20 is 1.107 mm, the image height (IH) of 1.0H is 2.626 mm, and the field of view (FOV) in the diagonal direction is 91.81°. The camera optical lens 20 can meet the design requirements of large aperture, wide-angle and ultra-thin, and chromatic aberrations on-axis and chromatic aberrations off-axis are adequately corrected. And the camera optical lens 20 has excellent optical characteristics.

### Third Embodiment

The meaning of symbols in the third embodiment is the same as that in the first embodiment.

FIG. 9 shows the camera optical lens 30 in the third embodiment of the present disclosure. The object side surface of the fourth lens L4 is convex in the paraxial region.

Table 5 and table 6 show the design data of the camera optical lens 30 in the third embodiment of the present disclosure.

TABLE 5

| | R | d | | nd | | vd | |
|---|---|---|---|---|---|---|---|
| S1 | ∞ | d0= | −0.066 | | | | |
| R1 | 1.930 | d1= | 0.509 | nd1 | 1.5444 | ν1 | 55.82 |
| R2 | −23.811 | d2= | 0.179 | | | | |
| R3 | −10.042 | d3= | 0.550 | nd2 | 1.5444 | ν2 | 55.82 |
| R4 | −1.273 | d4= | 0.028 | | | | |
| R5 | −1.162 | d5= | 0.209 | nd3 | 1.6610 | ν3 | 20.53 |
| R6 | −2333.897 | d6= | 0.146 | | | | |
| R7 | 28.760 | d7= | 0.736 | nd4 | 1.6153 | ν4 | 25.94 |
| R8 | −0.826 | d8= | 0.182 | | | | |
| R9 | 5.756 | d9= | 0.372 | nd5 | 1.6400 | ν5 | 23.54 |
| R10 | 0.744 | d10= | 0.441 | | | | |
| R11 | ∞ | d11= | 0.210 | ndg | 1.5168 | νg | 64.17 |
| R12 | ∞ | d12= | 0.348 | | | | |

Table 6 shows the aspheric data of each lens of the camera optical lens 30 in the third embodiment of the present disclosure.

TABLE 6

| | Conic | | | | | |
|---|---|---|---|---|---|---|
| | coefficients | Aspheric surface coefficients | | | | |
| | k | A4 | A6 | A8 | A10 | A12 |
| R1 | −2.6050E+01 | 4.7417E−01 | −3.8105E+00 | 3.8204E+01 | −2.7868E+02 | 1.2934E+03 |
| R2 | 7.7487E+02 | −1.5759E−01 | 1.2399E+00 | −3.6495E+01 | 3.7686E+02 | −2.1721E+03 |
| R3 | 2.3581E+02 | −6.7326E−01 | 1.9975E+01 | −5.0991E+02 | 8.2083E+03 | −8.9585E+04 |
| R4 | −3.0482E−01 | 2.3086E+00 | −4.4623E+01 | 6.4168E+02 | −5.9605E+03 | 3.4255E+04 |
| R5 | 7.4543E−02 | 2.6042E+00 | −4.3652E+01 | 5.1722E+02 | −3.9666E+03 | 1.7957E+04 |
| R6 | −2.1660E+02 | 1.1826E+00 | −2.0557E+01 | 1.9835E+02 | −1.2802E+03 | 5.6873E+03 |
| R7 | 7.6604E+02 | 5.3849E−01 | −6.6554E+00 | 2.5106E+01 | 8.5753E+01 | −1.4487E+03 |
| R8 | −1.0832E+00 | 3.3416E−01 | −2.0388E+00 | 9.0569E+00 | −1.3771E+01 | −6.2744E+01 |
| R9 | −2.5370E+00 | −4.5142E−01 | −1.7635E+00 | 1.6403E+01 | −6.1706E+01 | 1.4291E+02 |
| R10 | −1.0082E+00 | −1.3484E+00 | 2.9006E+00 | −5.1297E+00 | 6.7119E+00 | −6.4521E+00 |
| | Conic | | | | | |
| | coefficients | Aspheric surface coefficients | | | | |
| | k | A14 | A16 | A18 | A20 | A22 |
| R1 | −2.6050E+01 | −3.7550E+03 | 6.5636E+03 | −6.3030E+03 | 2.5667E+03 | 0.0000E+00 |
| R2 | 7.7487E+02 | 7.4638E+03 | −1.5219E+04 | 1.7023E+04 | −8.0605E+03 | 0.0000E+00 |
| R3 | 2.3581E+02 | 6.8925E+05 | −3.8314E+06 | 1.5583E+07 | −4.6445E+07 | 1.0036E+08 |
| R4 | −3.0482E−01 | −1.1592E+05 | 1.6206E+05 | 4.0496E+05 | −2.6982E+06 | 6.8747E+06 |
| R5 | 7.4543E−02 | −3.6739E+04 | −6.7455E+04 | 7.3265E+05 | −2.5414E+06 | 5.1981E+06 |
| R6 | −2.1660E+02 | −1.7923E+04 | 4.0899E+04 | −6.8150E+04 | 8.2721E+04 | −7.2132E+04 |
| R7 | 7.6604E+02 | 7.9271E+03 | −2.6037E+04 | 5.7501E+04 | −8.8478E+04 | 9.5300E+04 |
| R8 | −1.0832E+00 | 4.5132E+02 | −1.4366E+03 | 2.8941E+03 | −3.9684E+03 | 3.7583E+03 |
| R9 | −2.5370E+00 | −2.2769E+02 | 2.6172E+02 | −2.2109E+02 | 1.3737E+02 | −6.1952E+01 |
| R10 | −1.0082E+00 | 4.5979E+00 | −2.4453E+00 | 9.7144E−01 | −2.8646E−01 | 6.1720E−02 |

| | Conic | | | | |
|---|---|---|---|---|---|
| | coefficients | Aspheric surface coefficients | | | |
| | k | A24 | A26 | A28 | A30 |
| R1 | −2.6050E+01 | 0.0000E+00 | 0.0000E+00 | 0.0000E+00 | 0.0000E+00 |
| R2 | 7.7487E+02 | 0.0000E+00 | 0.0000E+00 | 0.0000E+00 | 0.0000E+00 |
| R3 | 2.3581E+02 | −1.5307E+08 | 1.5623E+08 | −9.5730E+07 | 2.6611E+07 |
| R4 | −3.0482E−01 | −1.0226E+07 | 9.2456E+06 | −4.7289E+06 | 1.0535E+06 |
| R5 | 7.4543E−02 | −6.7932E+06 | 5.5915E+06 | −2.6505E+06 | 5.5299E+05 |
| R6 | −2.1660E+02 | 4.3889E+04 | −1.7642E+04 | 4.1985E+03 | −4.4667E+02 |
| R7 | 7.6604E+02 | −7.0541E+04 | 3.4206E+04 | −9.7858E+03 | 1.2519E+03 |
| R8 | −1.0832E+00 | −2.4215E+03 | 1.0131E+03 | −2.4797E+02 | 2.6927E+01 |
| R9 | −2.5370E+00 | 1.9691E+01 | −4.1739E+00 | 5.2873E−01 | −3.0235E−02 |
| R10 | −1.0082E+00 | −9.4284E−03 | 9.6630E−04 | −5.9542E−05 | 1.6661E−06 |

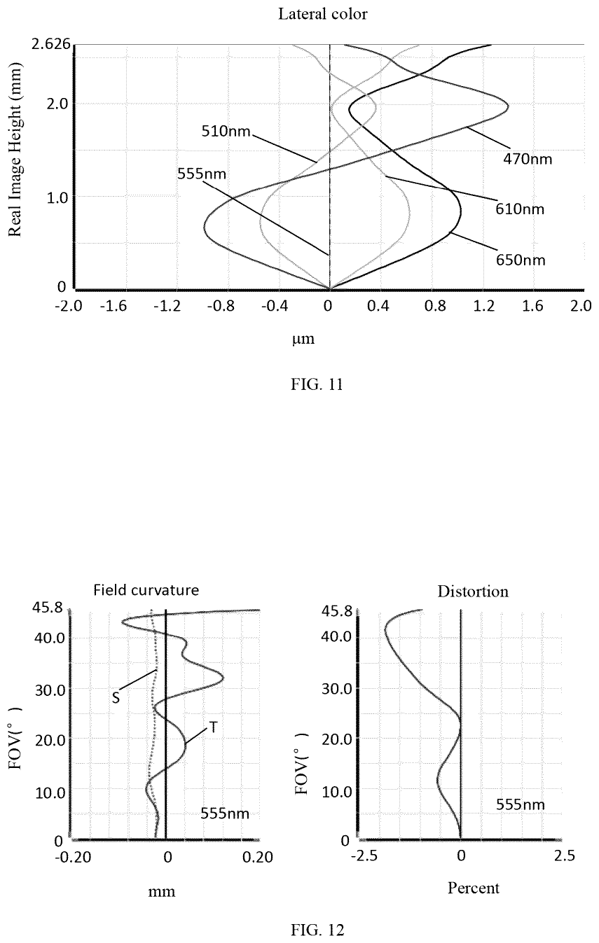

FIG. 10 and FIG. 11 respectively show the longitudinal aberration and lateral color schematic diagrams after light with wavelengths of 650 nm, 610 nm, 555 nm, 510 nm, and 470 nm passes through the camera optical lens 30 in the third embodiment. FIG. 12 shows the schematic diagrams of the field curvature and distortion after light with a wavelength of 555 nm passes through the camera optical lens 30 in the third embodiment. The field curvature S in FIG. 12 is a field curvature in the sagittal direction, and T is the field curvature in the meridian direction.

In this embodiment, the pupil entering diameter (ENPD) of the camera optical lens 30 is 1.124 mm, the image height (IH) of 1.0H is 2.626 mm, and the field of view (FOV) in the diagonal direction is 91.47°. The camera optical lens 30 can meet the design requirements of large aperture, wide-angle and ultra-thin, and chromatic aberrations on-axis and chromatic aberrations off-axis are adequately corrected. And the camera optical lens 30 has excellent optical characteristics.

### Fourth Embodiment

The meaning of symbols in the fourth embodiment is the same as that in the first embodiment.

FIG. 13 shows the camera optical lens 40 in the fourth embodiment of the present disclosure. The object side surface of the fourth lens L4 is concave in the paraxial region.

Table 7 and table 8 show the design data of the camera optical lens 40 in the fourth embodiment of the present disclosure.

TABLE 7

| | R | d | | nd | | vd | |
|---|---|---|---|---|---|---|---|
| S1 | ∞ | d0= | −0.041 | | | | |
| R1 | 1.569 | d1= | 0.585 | nd1 | 1.5444 | ν1 | 55.82 |
| R2 | −12.483 | d2= | 0.173 | | | | |
| R3 | −8.322 | d3= | 0.425 | nd2 | 1.5444 | ν2 | 55.82 |
| R4 | −1.386 | d4= | 0.063 | | | | |
| R5 | −1.022 | d5= | 0.192 | nd3 | 1.6610 | ν3 | 20.53 |
| R6 | −18.139 | d6= | 0.095 | | | | |
| R7 | −10.996 | d7= | 0.488 | nd4 | 1.6153 | ν4 | 25.94 |
| R8 | −0.815 | d8= | 0.042 | | | | |
| R9 | 52.856 | d9= | 0.696 | nd5 | 1.6400 | ν5 | 23.54 |
| R10 | 0.848 | d10= | 0.237 | | | | |
| R11 | ∞ | d11= | 0.210 | ndg | 1.5168 | νg | 64.17 |
| R12 | ∞ | d12= | 0.432 | | | | |

Table 8 shows the aspheric data of each lens of the camera optical lens 40 in the fourth embodiment of the present disclosure.

TABLE 8

| | conic coefficients | aspheric surface coefficients | | | | |
|---|---|---|---|---|---|---|
| | k | A4 | A6 | A8 | A10 | A12 |
| R1 | −1.4924E+01 | 5.1482E−01 | −3.7492E+00 | 3.6854E+01 | −2.7527E+02 | 1.2965E+03 |
| R2 | 3.4965E+02 | −2.5754E−01 | 1.1963E+00 | −3.6636E+01 | 3.8112E+02 | −2.1923E+03 |
| R3 | 1.4437E+02 | −6.8929E−01 | 1.9168E+01 | −5.0848E+02 | 8.2102E+03 | −8.9586E+04 |
| R4 | −1.6813E+00 | 2.5117E+00 | −4.5185E+01 | 6.4135E+02 | −5.9573E+03 | 3.4252E+04 |
| R5 | −1.6895E+00 | 2.8705E+00 | −4.4164E+01 | 5.1625E+02 | −3.9645E+03 | 1.7956E+04 |
| R6 | 3.1927E+02 | 1.1575E+00 | −2.0426E+01 | 1.9831E+02 | −1.2803E+03 | 5.6874E+03 |
| R7 | 1.3084E+02 | 5.0147E−01 | −6.6283E+00 | 2.5148E+01 | 8.5610E+01 | −1.4485E+03 |
| R8 | −9.2170E−01 | 3.0911E−01 | −2.0272E+00 | 9.0816E+00 | −1.3891E+01 | −6.2801E+01 |
| R9 | −1.6060E+00 | −5.1394E−01 | −1.6765E+00 | 1.6161E+01 | −6.1589E+01 | 1.4296E+02 |
| R10 | −9.5628E−01 | −1.3169E+00 | 2.8894E+00 | −5.1336E+00 | 6.7128E+00 | −6.4519E+00 |
| | conic coefficients | aspheric surface coefficients | | | | |
| | k | A14 | A16 | A18 | A20 | A22 |
| R1 | −1.4924E+01 | −3.7652E+03 | 6.5477E+03 | −6.4247E+03 | 2.9269E+03 | 0.0000E+00 |
| R2 | 3.4965E+02 | 7.4998E+03 | −1.5180E+04 | 1.6788E+04 | −7.7823E+03 | 0.0000E+00 |
| R3 | 1.4437E+02 | 6.8925E+05 | −3.8314E+06 | 1.5583E+07 | −4.6445E+07 | 1.0036E+08 |
| R4 | −1.6813E+00 | −1.1592E+05 | 1.6206E+05 | 4.0495E+05 | −2.6982E+06 | 6.8748E+06 |
| R5 | −1.6895E+00 | −3.6739E+04 | −6.7460E+04 | 7.3264E+05 | −2.5414E+06 | 5.1981E+06 |
| R6 | 3.1927E+02 | −1.7923E+04 | 4.0899E+04 | −6.8150E+04 | 8.2721E+04 | −7.2132E+04 |
| R7 | 1.3084E+02 | 7.9272E+03 | −2.6037E+04 | 5.7501E+04 | −8.8479E+04 | 9.5299E+04 |
| R8 | −9.2170E−01 | 4.5128E+02 | −1.4372E+03 | 2.8954E+03 | −3.9683E+03 | 3.7576E+03 |
| R9 | −1.6060E+00 | −2.2771E+02 | 2.6170E+02 | −2.2110E+02 | 1.3737E+02 | −6.1954E+01 |
| R10 | −9.5628E−01 | 4.5979E+00 | −2.4453E+00 | 9.7143E−01 | −2.8646E−01 | 6.1720E−02 |

| | conic coefficients | aspheric surface coefficients | | | |
|---|---|---|---|---|---|
| | k | A24 | A26 | A28 | A30 |
| R1 | −1.4924E+01 | 0.0000E+00 | 0.0000E+00 | 0.0000E+00 | 0.0000E+00 |
| R2 | 3.4965E+02 | 0.0000E+00 | 0.0000E+00 | 0.0000E+00 | 0.0000E+00 |
| R3 | 1.4437E+02 | −1.5307E+08 | 1.5623E+08 | −9.5730E+07 | 2.6610E+07 |
| R4 | −1.6813E+00 | −1.0226E+07 | 9.2456E+06 | −4.7289E+06 | 1.0535E+06 |
| R5 | −1.6895E+00 | −6.7931E+06 | 5.5915E+06 | −2.6505E+06 | 5.5301E+05 |
| R6 | 3.1927E+02 | 4.3889E+04 | −1.7642E+04 | 4.1983E+03 | −4.4675E+02 |
| R7 | 1.3084E+02 | −7.0541E+04 | 3.4206E+04 | −9.7855E+03 | 1.2516E+03 |
| R8 | −9.2170E−01 | −2.4218E+03 | 1.0134E+03 | −2.4740E+02 | 2.6482E+01 |
| R9 | −1.6060E+00 | 1.9691E+01 | −4.1724E+00 | 5.2946E−01 | −2.9328E−02 |
| R10 | −9.5628E−01 | −9.4282E−03 | 9.6635E−04 | −5.9569E−05 | 1.6686E−06 |

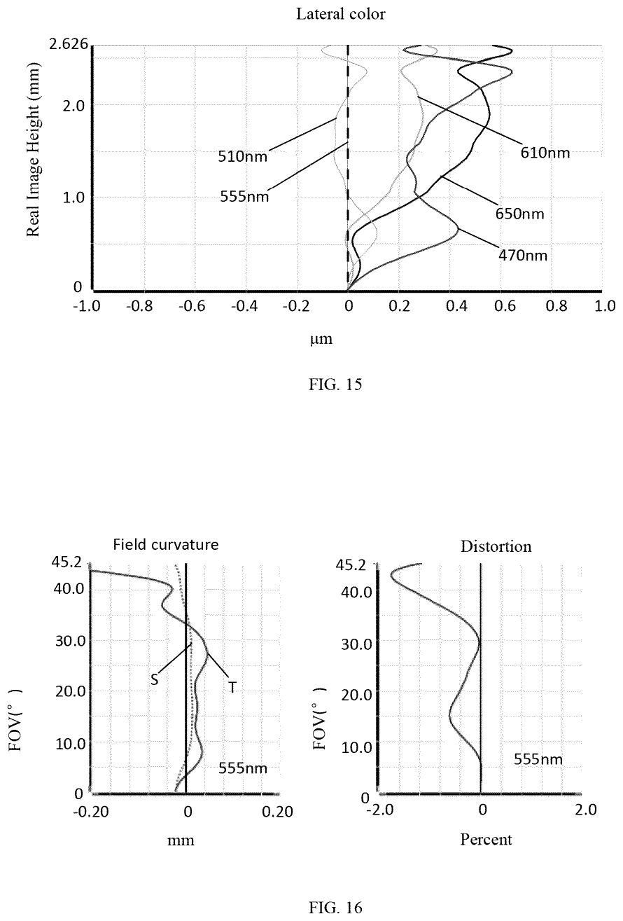

FIG. 14 and FIG. 15 respectively show the longitudinal aberration and lateral color schematic diagrams after light with wavelengths of 650 nm, 610 nm, 555 nm, 510 nm, and 470 nm passes through the camera optical lens 40 in the fourth embodiment. FIG. 16 shows the schematic diagrams of the field curvature and distortion after light with a wavelength of 555 nm passes through the camera optical lens 40 in the fourth embodiment. The field curvature S in FIG. 16 is a field curvature in the sagittal direction, and T is the field curvature in the meridian direction.

In this embodiment, the pupil entering diameter (ENPD) of the camera optical lens 40 is 1.144 mm, the image height of (IH) 1.0H is 2.626 mm, and the field of view (FOV) in the diagonal direction is 90.34°. The camera optical lens 40 can meet the design requirements of large aperture, wide-angle and ultra-thin, and chromatic aberrations on-axis and chromatic aberrations off-axis are adequately corrected. And the camera optical lens 40 has excellent optical characteristics.

As shown in table 11, which appears later, the values corresponding with the parameters in the first embodiment, the second embodiment, the third embodiment, and the fourth embodiment are fixed in the conditions.

### Contrast Embodiment

The meaning of symbols in the contrast embodiment is the same as that in the first embodiment.

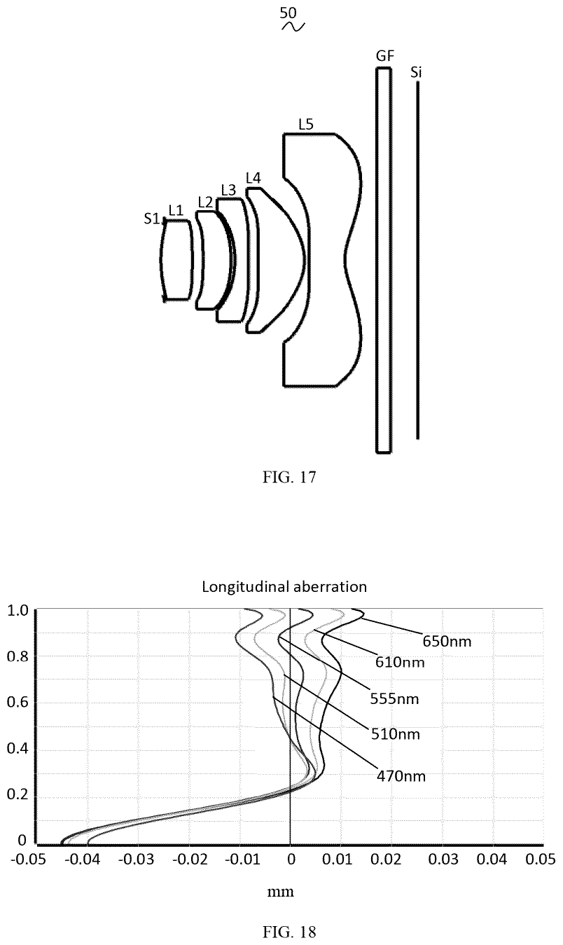

FIG. 17 shows the camera optical lens 50 in the contrast embodiment. The object side surface of the fourth lens L4 is concave in the paraxial region.

Table 9 and table 10 show the design data of the camera optical lens 50 in the contrast embodiment.

TABLE 9

| | R | d | | nd | | vd | |
|---|---|---|---|---|---|---|---|
| S1 | ∞ | d0= | −0.048 | | | | |
| R1 | 2.001 | d1= | 0.481 | nd1 | 1.5444 | ν1 | 55.82 |
| R2 | −14.567 | d2= | 0.166 | | | | |
| R3 | −9.117 | d3= | 0.429 | nd2 | 1.5444 | ν2 | 55.82 |
| R4 | −1.400 | d4= | 0.061 | | | | |
| R5 | −1.122 | d5= | 0.206 | nd3 | 1.6610 | ν3 | 20.53 |
| R6 | −15.007 | d6= | 0.150 | | | | |
| R7 | −34.966 | d7= | 0.714 | nd4 | 1.6153 | ν4 | 25.94 |
| R8 | −0.835 | d8= | 0.068 | | | | |
| R9 | 4.657 | d9= | 0.551 | nd5 | 1.6400 | ν5 | 23.54 |
| R10 | 0.760 | d10= | 0.494 | | | | |
| R11 | ∞ | d11= | 0.210 | ndg | 1.5168 | νg | 64.17 |
| R12 | ∞ | d12= | 0.413 | | | | |

Table 10 shows the aspheric data of each lens of the camera optical lens 50 in the contrast embodiment.

TABLE 10

| | Conic | | | | | |
|---|---|---|---|---|---|---|
| | coefficients | Aspheric surface coefficients | | | | |
| | k | A4 | A6 | A8 | A10 | A12 |
| R1 | −2.7862E+01 | 4.7926E−01 | −3.8778E+00 | 3.8328E+01 | −2.7910E+02 | 1.2930E+03 |
| R2 | 4.6840E+02 | −1.4757E−01 | 1.2042E+00 | −3.6570E+01 | 3.7712E+02 | −2.1718E+03 |
| R3 | 9.3511E+01 | −6.7738E−01 | 1.9628E+01 | −5.0952E+02 | 8.2091E+03 | −8.9585E+04 |
| R4 | 3.1070E−02 | 2.2402E+00 | −4.4570E+01 | 6.4169E+02 | −5.9606E+03 | 3.4255E+04 |
| R5 | 4.4393E−02 | 2.6664E+00 | −4.3717E+01 | 5.1721E+02 | −3.9666E+03 | 1.7957E+04 |
| R6 | 1.4107E+02 | 1.2010E+00 | −2.0540E+01 | 1.9837E+02 | −1.2802E+03 | 5.6873E+03 |
| R7 | 8.4546E+02 | 5.2058E−01 | −6.6122E+00 | 2.5131E+01 | 8.5740E+01 | −1.4487E+03 |
| R8 | −1.0037E+00 | 3.0350E−01 | −1.9798E+00 | 9.0368E+00 | −1.3788E+01 | −6.2743E+01 |
| R9 | −3.6443E−01 | −4.3733E−01 | −1.7849E+00 | 1.6405E+01 | −6.1708E+01 | 1.4290E+02 |
| R10 | −1.0180E+00 | −1.3370E+00 | 2.8937E+00 | −5.1292E+00 | 6.7119E+00 | −6.4521E+00 |
| | Conic | | | | | |
| | coefficients | Aspheric surface coefficients | | | | |
| | k | A14 | A16 | A18 | A20 | A22 |
| R1 | −2.7862E+01 | −3.7532E+03 | 6.5662E+03 | −6.3186E+03 | 2.5833E+03 | 0.0000E+00 |
| R2 | 4.6840E+02 | 7.4652E+03 | −1.5227E+04 | 1.7005E+04 | −7.9944E+03 | 0.0000E+00 |
| R3 | 9.3511E+01 | 6.8925E+05 | −3.8314E+06 | 1.5583E+07 | −4.6445E+07 | 1.0036E+08 |
| R4 | 3.1070E−02 | −1.1592E+05 | 1.6206E+05 | 4.0496E+05 | −2.6982E+06 | 6.8747E+06 |
| R5 | 4.4393E−02 | −3.6739E+04 | −6.7456E+04 | 7.3265E+05 | −2.5414E+06 | 5.1981E+06 |
| R6 | 1.4107E+02 | −1.7923E+04 | 4.0899E+04 | −6.8150E+04 | 8.2721E+04 | −7.2132E+04 |
| R7 | 8.4546E+02 | 7.9271E+03 | −2.6037E+04 | 5.7501E+04 | −8.8478E+04 | 9.5300E+04 |
| R8 | −1.0037E+00 | 4.5132E+02 | −1.4366E+03 | 2.8941E+03 | −3.9683E+03 | 3.7583E+03 |
| R9 | −3.6443E−01 | −2.2769E+02 | 2.6172E+02 | −2.2109E+02 | 1.3737E+02 | −6.1952E+01 |
| R10 | −1.0180E+00 | 4.5979E+00 | −2.4453E+00 | 9.7144E−01 | −2.8646E−01 | 6.1720E−02 |

| | Conic | | | | |
|---|---|---|---|---|---|
| | coefficients | Aspheric surface coefficients | | | |
| | k | A24 | A26 | A28 | A30 |
| R1 | −2.7862E+01 | 0.0000E+00 | 0.0000E+00 | 0.0000E+00 | 0.0000E+00 |
| R2 | 4.6840E+02 | 0.0000E+00 | 0.0000E+00 | 0.0000E+00 | 0.0000E+00 |
| R3 | 9.3511E+01 | −1.5307E+08 | 1.5623E+08 | −9.5730E+07 | 2.6610E+07 |
| R4 | 3.1070E−02 | −1.0226E+07 | 9.2456E+06 | −4.7289E+06 | 1.0535E+06 |
| R5 | 4.4393E−02 | −6.7932E+06 | 5.5915E+06 | −2.6505E+06 | 5.5299E+05 |
| R6 | 1.4107E+02 | 4.3889E+04 | −1.7642E+04 | 4.1985E+03 | −4.4667E+02 |
| R7 | 8.4546E+02 | −7.0541E+04 | 3.4206E+04 | −9.7858E+03 | 1.2519E+03 |
| R8 | −1.0037E+00 | −2.4215E+03 | 1.0131E+03 | −2.4797E+02 | 2.6927E+01 |
| R9 | −3.6443E−01 | 1.9691E+01 | −4.1739E+00 | 5.2873E−01 | −3.0237E−02 |
| R10 | −1.0180E+00 | −9.4284E−03 | 9.6630E−04 | −5.9542E−05 | 1.6661E−06 |

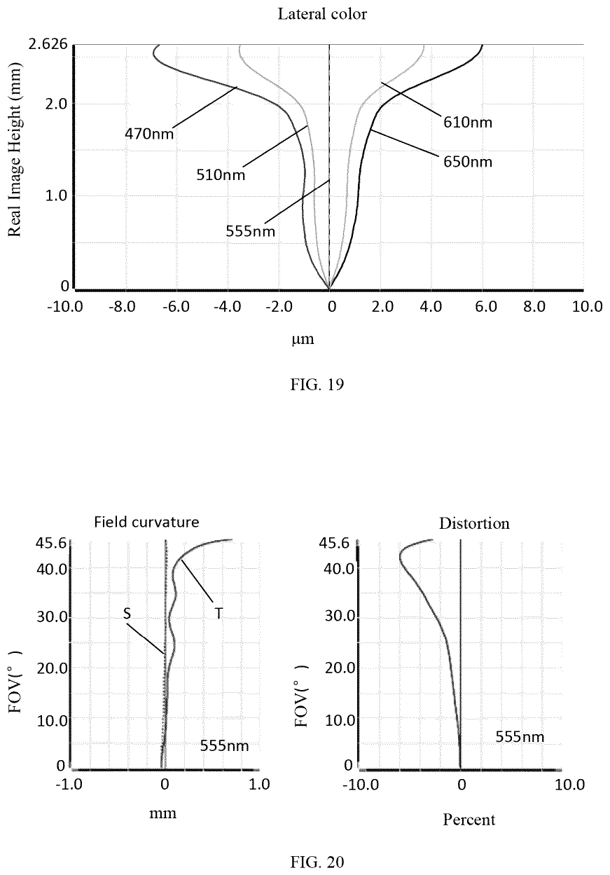

FIG. 18 and FIG. 19 respectively show the longitudinal aberration and lateral color schematic diagrams after light with wavelengths of 650 nm, 610 nm, 555 nm, 510 nm, and 470 nm passes through the camera optical lens 50 in the contrast embodiment. FIG. 20 shows the schematic diagrams of the field curvature and distortion after light with a wavelength of 555 nm passes through the camera optical lens 60 in the contrast embodiment. The field curvature S in FIG. 20 is a field curvature in the sagittal direction, and T is the field curvature in the meridian direction.

Table 11 below shows the various values in this embodiment in accordance with the above conditions. Obviously, the camera optical lens 50 in this embodiment does not satisfy the above condition: 0.12≤d1/TTL≤0.20, which has poor image performance.

In the contrast embodiment, the pupil entering diameter (ENPD) of the camera optical lens 50 is 1.140 mm, the image height (IH) of 1.0H is 2.626 mm, and the field of view (FOV) in the diagonal direction is 91.21°. The camera optical lens 50 does not meet the design requirements of large aperture, wide-angle and ultra-thin.

TABLE 11

| | First | Second | Third | Fourth | Contrast |
|---|---|---|---|---|---|
| Parameters and conditions | Embodiment | Embodiment | Embodiment | Embodiment | Embodiment |
| d1/TTL | 0.158 | 0.20 | 0.13 | 0.16 | 0.12 |
| (R5 + R6)/(R5 − R6) | −1.104 | −1.30 | −1.00 | −1.12 | −1.16 |
| R3/R4 | 8.221 | 14.98 | 7.89 | 6.00 | 6.51 |
| f | 2.686 | 2.503 | 2.541 | 2.585 | 2.577 |
| f1 | 3.241 | 3.372 | 3.291 | 2.590 | 3.255 |
| f2 | 2.896 | 2.645 | 2.612 | 2.981 | 2.969 |
| f3 | −1.784 | −1.827 | −1.744 | −1.632 | −1.829 |
| f4 | 1.375 | 1.407 | 1.309 | 1.395 | 1.370 |
| f5 | −1.467 | −1.397 | −1.365 | −1.343 | −1.491 |
| FNO | 2.214 | 2.261 | 2.261 | 2.260 | 2.261 |
| TTL | 4.081 | 3.871 | 3.910 | 3.638 | 3.943 |

It can be understood by a person of ordinary skill in the art that the above embodiments are specific embodiments of the realization of the present disclosure, and that various changes can be made thereto in form and detail in practical application without departing from the spirit and scope of the present disclosure.

What is claimed is:

1. A camera optical lens, comprising five lenses, the five lenses from an object side to an image side in sequence being:
a first lens having a positive refractive power;
a second lens having a positive refractive power;
a third lens having a negative refractive power;
a fourth lens having a positive refractive power;
a fifth lens having a negative refractive power;
wherein the camera lens satisfies the following conditions:
$$\begin{matrix}0.12 \leq d 1 / TTL \leq 0.2 ; \\ 5. \leq R 3 / R 4 \leq 15. ; \\ - 1.3 \leq ( R 5 + R 6 ) / ( R 5 - R 6 ) \leq - 1. ;\end{matrix}$$
where,
d1 represents a thickness on-axis of the first lens;
TTL represents a total track length of the camera optical lens;
R3 represents a central curvature radius of the object side surface of the second lens;
R4 represents a central curvature radius of the image side surface of the second lens;
R5 represents a central curvature radius of the object side surface of the third lens;
R6 represents a central curvature radius of the image side surface of the third lens.

2. The camera optical lens according to claim 1, wherein the camera optical lens further satisfies following conditions:
$$1. \leq f 1 / f \leq 1.35 ;$$
where,
f1 represents a focal length of the first lens;
f represents a focal length of the camera optical lens.

3. The camera optical lens according to claim 1, wherein the camera optical lens further satisfies the following conditions:
$$0.7 \leq d 7 / d 9 \leq 2. ;$$
where,
d7 represents a thickness on-axis of the fourth lens;
d9 represents a thickness on-axis of the fifth lens.

4. The camera optical lens according to claim 1, wherein the camera optical lens further satisfies the following conditions:
$$( IH * FOV ) / D \leq 166.66 ° ;$$
where,
IH represents an image height of 1.0H of the camera optical lens;
FOV represents a field of view in a diagonal direction of the camera optical lens;
D represents a diameter of an object side surface of the first lens.

5. The camera optical lens according to claim 1, wherein the camera optical lens further satisfies the following conditions:
$$3. \leq d 3 / d 4 \leq 20. ;$$
where,
d3 represents a thickness on-axis of the second lens;
d4 represents a distance on-axis from an image side surface of the second lens to an object side surface of the third lens.

6. The camera optical lens according to claim 1, wherein an object side surface of the first lens is convex in the paraxial region, an image side surface of the first lens is convex in the paraxial region; and the camera optical lens further satisfies the following conditions:
$$- 1.7 \leq ( R 1 + R 2 ) / ( R 1 - R 2 ) \leq - 0.51 ;$$
where,
R1 represents a central curvature radius of the object side surface of the first lens;
R2 represents a central curvature radius of the image side surface of the first lens.

7. The camera optical lens according to claim 1, wherein an object side surface of the second lens is concave in the paraxial region, an image side surface of the second lens is convex in the paraxial region; and the camera optical lens further satisfies the following conditions:
$$\begin{matrix}0.51 \leq f 2 / f \leq 1.73 ; \\ 0.57 \leq ( R 3 + R 4 ) / ( R 3 - R 4 ) \leq 2.1 ; \\ 0.04 \leq d 3 / TTL \leq 0.21 ;\end{matrix}$$
where,
f2 represents a focal length of the second lens;
f represents a focal length of the camera optical lens;
d3 represents a thickness on-axis of the second lens.

8. The camera optical lens according to claim 1, wherein an object side surface of the third lens is concave in the paraxial region, an image side surface of the third lens is convex in the paraxial region; and the camera optical lens further satisfies the following conditions:
$$\begin{matrix}- 1.46 \leq f 3 / f \leq - 0.42 ; \\ 0.02 \leq d 5 / TTL \leq 0.08 ;\end{matrix}$$
where,
f3 represents a focal length of the third lens;
f represents a focal length of the camera optical lens;
TTL represents a total track length of the camera optical lens.

9. The camera optical lens according to claim 1, wherein an image side surface of the fourth lens is convex in the paraxial region; and the camera optical lens further satisfies the following conditions:
$$\begin{matrix}0.26 \leq f 4 / f \leq 0.84 ; \\ 0.47 \leq ( R 7 + R 8 ) / ( R 7 - R 8 ) \leq 1.74 ; \\ 0.07 \leq d 7 / TTL \leq 0.28 ;\end{matrix}$$
where,
f4 represents a focal length of the fourth lens;
f represents a focal length of the camera optical lens;
R7 represents a central curvature radius of the object side surface of the fourth lens;
R8 represents a central curvature radius of the image side surface of the fourth lens;
d7 represents a thickness on-axis of the fourth lens.

10. The camera optical lens according to claim 1, wherein an object side surface of the fifth lens is convex in the paraxial region, an image side surface of the fifth lens is concave in the paraxial region; and the camera optical lens further satisfies the following conditions:
$$\begin{matrix}- 1.12 \leq f 5 / f \leq - 0.35 ; \\ 0.52 \leq ( R 9 + R 10 ) / ( R 9 - R 10 ) \leq 2.07 ; \\ 0.05 \leq d 9 / TTL \leq 0.29 ;\end{matrix}$$
where,
f5 represents a focal length of the fifth lens;
f represents a focal length of the camera optical lens;
R9 represents a central curvature radius of the object side surface of the fifth lens;
R10 represents a central curvature radius of the image side surface of the fifth lens;
d9 represents a thickness on-axis of the fifth lens.
